(19) United States
(12) Patent Application Publication
(10) Pub. No.: US 2016/0356440 A1
(43) Pub. Date: Dec. 8, 2016

(54) LIGHT BAR

(71) Applicant: DONGGUAN JIASHENG LIGHTING TECHNOLOGY CO. LTD, Dongguan City (CN)

(72) Inventor: Shuisheng Xu, Dongguan City (CN)

(21) Appl. No.: 15/042,400

(22) Filed: Feb. 12, 2016

(30) Foreign Application Priority Data
Jun. 4, 2015 (CN) 201520386604.4

(51) Int. Cl. F21S 4/24; F21V 23/00; F21V 29/70; F21V 19/00

(52) U.S. Cl. CPC F21S 4/24; F21V 19/005; F21V 23/002; F21V 29/70; F21Y 2103/003

(57) ABSTRACT

A light bar is disclosed, including a conducting wire, a plurality of LED lamps electrically connected to the conducting wire, and an insulating sleeve sleeved on the conducting wire and the LED lamps, wherein at least one end of the conducting wire is exposed outside the insulating sleeve, the insulating sleeve includes a first insulating portion made of a transparent insulating material and a second insulating portion made of a heat dispersing insulating material, the first insulating portion is arranged so as to correspond to a light-emitting side of the LED lamps, the second insulating portion is arranged so as to correspond to a back side of the LED lamps, and the first insulating portion and the second insulating portion are integratedly molded by pressing. Compared with the light bar in the prior art, the light bar disclosed herein can produce more power than an equivalent light bar. In addition, it is smaller in overall dimensions and able to dissipate the heat generated by the light bar timely. Moreover, it is convenient to manufacture, saving materials and reducing the production cost and material cost.

### FIELD

The disclosure relates to the technical field of lighting, and more particularly, to a light bar.

### BACKGROUND

There are mainly two traditional methods for making a light bar. One method is to connect a number of LED lamps in parallel on two power lines, and cover them with a transparent insulating material or use a device to mold them in one body with the transparent insulating material by pressing. The other method is to arrange a number of LED lamps on a circuit board which serves as a carrier of the LED, electrically connect the circuit board to a power line and arrange an external transparent insulating material.

In either traditional method of making the light bar, if the light bar has a long length of lamps in series, there may be a larger voltage drop produced by the power line in the light bar, and large amount of heat may be generated by the power line. In this case, a heat dispersing material may be required to be arranged on the back of the light bar to decrease the temperature raised by the heating from the power line of the light bar, that is, the production of the light bar requires post forming process. The post forming process is high in cost so as to raise the cost of light bar.

### SUMMARY

Based on above, the objective of the present disclosure is to overcome the defects of the prior art by providing a light bar which is easy to manufacture.

According to an aspect of the present disclosure, a light bar is provided, including a conducting wire, a plurality of LED lamps electrically connected to the conducting wire, and an insulating sleeve sleeved on the conducting wire and the LED lamps, wherein at least one end of the conducting wire is exposed outside the insulating sleeve, the insulating sleeve includes a first insulating portion made of a transparent insulating material and a second insulating portion made of a heat dispersing insulating material, the first insulating portion is arranged so as to correspond to a light-emitting side of the LED lamps, the second insulating portion is arranged so as to correspond to a back side of the LED lamps, and the first insulating portion and the second insulating portion are integratedly molded by pressing.

In one embodiment, there are two conducting wires, a plurality of circuit boards are arranged between the two conducting wires, the plurality of circuit boards are electrically connected to the conducting wires through conductive parts, and the LED lamps are arranged on the circuit boards.

In one embodiment, the conductive part is a sheet metal, one end of the sheet metal is welded to the circuit board, and the other end of the sheet metal is electrically connected to the conducting wire.

In one embodiment, the other end of the sheet metal is bent to form a bending portion, and the conducting wire is located in the bending portion.

In one embodiment, the plurality of circuit boards are equally spaced along the conducting wire, and the distance between adjacent two circuit boards is 5 to 20 cm.

In one embodiment, the circuit board is a flexible circuit board, the first insulating portion is located on one side of the circuit board where the LED lamps are arranged, and the second insulating portion is located on the other side of the circuit board.

In one embodiment, there is a plurality of LED lamps on the circuit board, and the plurality of LED lamps are arranged evenly on the circuit board.

In one embodiment, a plug is coupled to an end of the conducting wire.

The principles and effects of the above technical solutions are illustrated below. For the above light bar, the transparent insulating material in the molten state is pressed against the light-emitting side of the LED lamps to be cooled to form the first insulating portion, and the heat dispersing insulating material in the molten state is pressed against the back side of the LED lamps to be cooled to form the second insulating portion. The first insulating portion and the second insulating portion are joined up by using a mould during the extrusion process to get an insulating sleeve sleeved on the conducting wire and the LED lamps. Light from the LED lamps can emit from the first insulating portion, and heat generated by the LED lamps and the conducting wire can be facilitated to dissipate from the second insulating portion. As such, compared with the light bar in the prior art, the light bar disclosed herein can produce more power than an equivalent light bar, is smaller in overall dimensions, can dissipate the heat generated by the light bar timely, is convenient to manufacture, can save materials and reduce the production cost and material cost.

### BRIEF DESCRIPTION OF THE DRAWINGS

FIG. 1 is a structural schematic diagram illuminating a light bar according to one embodiment of the present disclosure.

FIG. 2 is a structural schematic diagram illuminating a connection between the flexible circuit board and the conducting wire inside the light bar according to one embodiment of the present disclosure.

Explanation of the reference signs in the drawings:

10 flexible circuit board; 11 LED lamp; 12 conducting wire; 13 conductive part; 20 first insulating portion; and 30 second insulating portion.

### DETAILED DESCRIPTION OF THE PREFERRED EMBODIMENTS

The embodiments of the present disclosure will be described hereinafter with reference to the drawings.

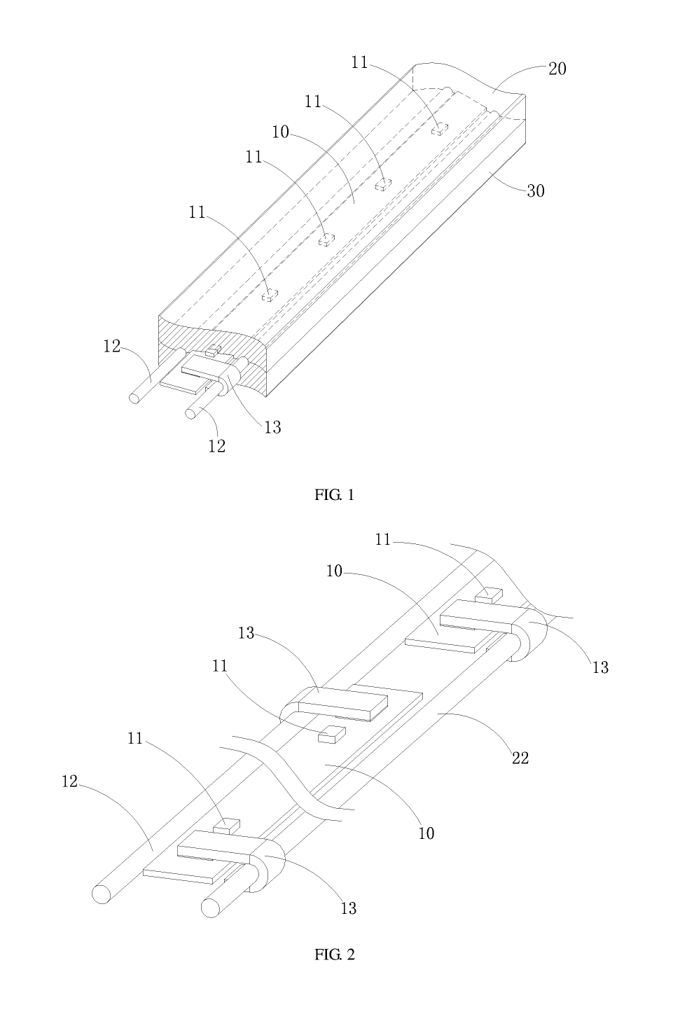

As shown in FIG. 1, the light bar according to the present disclosure includes a conducting wire 12, a plurality of LED lamps 11 and an insulating sleeve (not shown). The LED lamps 11 are electrically connected to the conducting wire 12. At least one end of the conducting wire 12 is exposed outside the insulating sleeve. In the embodiment, a plug (not shown) is coupled to an end of the conducting wire 12. Once the plug is connected to a socket, the light bar may be powered to emit light. The insulating sleeve may be sleeved on the conducting wire 12 and the LED lamps 11. The insulating sleeve includes a first insulating portion 20 made of a transparent insulating material and a second insulating portion 30 made of a heat dispersing insulating material. The first insulating portion 20 is arranged so as to correspond to a light-emitting side of the LED lamps 11, the second insulating portion 30 is arranged so as to correspond to a back side of the LED lamps 11, and the first insulating portion 20 and the second insulating portion 30 are integratedly molded by pressing.

For the above light bar, the transparent insulating material in the molten state is pressed against the light-emitting side of the LED lamps 11 to be cooled to form the first insulating portion 20, and the heat dispersing insulating material in the molten state is pressed against the back side of the LED lamps 11 to be cooled to form the second insulating portion 30. The first insulating portion 20 and the second insulating portion 30 are joined up by using a mould during the extrusion process to get an insulating sleeve sleeved on the conducting wire 12 and the LED lamps 11. Light from the LED lamps 11 can emit from the first insulating portion 20, and heat generated by the LED lamps 11 and the conducting wire 12 can be facilitated to dissipate from the second insulating portion 30. As such, compared with the light bar in the prior art, the light bar disclosed herein can produce more power than an equivalent light bar, is smaller in overall dimensions, can dissipate the heat generated by the light bar timely, is convenient to manufacture, can save materials and reduce the production cost and material cost.

As shown in FIG. 2, there are two conducting wires 12, a plurality of circuit boards (the circuit boards shown are flexible circuit boards 10) are arranged between the two conducting wires 12. The plurality of circuit boards are electrically connected to the conducting wires 12 through conductive parts 13. The LED lamps 11 are arranged on the circuit boards. The plurality of circuit boards are equally spaced along the conducting wire 12, and the distance between adjacent two circuit boards is 5 to 20 cm. In this way, the light bar can be cut off at a position between adjacent two circuit boards according to the user's requirement for the length of the light bar, to meet the user's requirement for the length of the light bar.

In the embodiment, the conductive part 13 is a sheet metal, one end of the sheet metal is welded to the circuit board, and the other end of the sheet metal is electrically connected to the conducting wire 12. In one embodiment, the other end of the sheet metal is bent to form a bending portion, and the conducting wire 12 is located in the bending portion. It is convenient to connect the conducting wire 12 to the bending portion bent from the sheet metal, with a good electrical contact performance.

The circuit board is a flexible circuit board 10 which can be free to bend so that the light bar can be suitable for various occasions in the process of arrangement, with a good using effect. The first insulating portion 20 is located on one side of the circuit board where the LED lamps 11 are arranged, and the second insulating portion 30 is located on the other side of the circuit board. There is a plurality of LED lamps 11 on the circuit board, and the plurality of LED lamps 11 are arranged evenly on the circuit board. In this way, the light bar has a uniform lighting with a good lighting effect.

Various technical features in the above embodiments can be combined arbitrarily. Not all possible combinations of the technical features in the above embodiments are described herein for the purpose of a brief description. However, it will be understood that the various technical features in the above embodiments can be combined once there is no conflict between these technical features, and such combinations are included within the scope of the disclosed embodiments.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

1. A light bar, comprising:
a conducting wire;
a plurality of LED lamps electrically connected to the conducting wire; and
an insulating sleeve sleeved on the conducting wire and the LED lamps, wherein at least one end of the conducting wire is exposed outside the insulating sleeve, the insulating sleeve comprising a first insulating portion made of a transparent insulating material and a second insulating portion made of a heat dispersing insulating material; the first insulating portion is arranged so as to correspond to a light-emitting side of the LED lamps, the second insulating portion is arranged so as to correspond to a back side of the LED lamps, and the first insulating portion and the second insulating portion are integratedly molded by pressing.

2. The light bar of claim 1, wherein there are two conducting wires, a plurality of circuit boards are arranged between the two conducting wires, the plurality of circuit boards are electrically connected to the conducting wires through conductive parts, and the LED lamps are arranged on the circuit boards.

3. The light bar of claim 2, wherein the conductive part is a sheet metal, one end of the sheet metal is welded to the circuit board, and the other end of the sheet metal is electrically connected to the conducting wire.

4. The light bar of claim 3, wherein the other end of the sheet metal is bent to form a bending portion, and the conducting wire is located in the bending portion.

5. The light bar of claim 2, wherein the plurality of circuit boards are equally spaced along the conducting wire, and the distance between adjacent two circuit boards is 5 to 20 cm.

6. The light bar of claim 2, wherein the circuit board is a flexible circuit board, the first insulating portion is located on one side of the circuit board where the LED lamps are arranged, and the second insulating portion is located on the other side of the circuit board.

7. The light bar of claim 2, wherein there is a plurality of LED lamps on the circuit board, and the plurality of LED lamps are arranged evenly on the circuit board.

8. The light bar of any one of claim 7, wherein a plug is coupled to an end of the conducting wire.
